(19) United States
(12) Patent Application Publication
(10) Pub. No.: US 2007/0187580 A1
(43) Pub. Date: Aug. 16, 2007

(54) Photoluminescent light sources, and scanned beam systems and methods of using same

(75) Inventors: Martin Kykta, Woodinville, WA (US); John R. Lewis, Bellevue, WA (US); Clarence T. Tegreene, Bellevue, WA (US); Christopher A. Wiklof, Everett, WA (US)

Correspondence Address: Microvision, Inc., 6222 185th Ave. NE, Redmond, WA, 98052, US

(73) Assignee: Microvision, Inc.

(21) Appl. No.: 11/353,718

(22) Filed: Feb. 14, 2006

(51) Int. Cl. G01J 1/04

(52) U.S. Cl. 250/227.15

(57) ABSTRACT

A photoluminescent light source includes an excitation light source operable to emit light at a primary wavelength and a photoluminescent material optically coupled to the excitation light source. The photoluminescent material has a characteristic to emit light at a secondary wavelength in response to absorbing light at the primary wavelength. Scanned beam systems employing photoluminescent light sources and methods of using the photoluminescent light sources are also disclosed.

### TECHNICAL FIELD

This invention relates generally to photoluminescent light sources, and more specifically to methods and apparatuses for utilizing photoluminescent light sources in scanned beam devices.

### BACKGROUND

Light sources are used in a variety of devices that display an image to a user. Some color displays use multiple light sources; such as red, green, and blue light sources; to render a color image to a user. Many existing light sources suffer from one or more deficiencies. For example, diode pumped solid state lasers (DPSSL), gas lasers, and dye lasers used in conjunction with acoustic-optic modulators (AOMs) may be bulky, expensive, and consume large amounts of power. Light emitting diodes (LEDs), such as red, green, and blue LEDs may provide relatively lower levels of light intensity than typically desired for some applications. Furthermore, blue and green laser diodes can be expensive.

### SUMMARY

According to one aspect, a photoluminescent light source includes an excitation light source operable to emit light at a primary wavelength and a target, formed of a photoluminescent material, optically coupled to the excitation light source. The photoluminescent material has a characteristic to emit light at a secondary wavelength in response to absorbing light at the primary wavelength. In some aspects, the photoluminescent light source further includes a focusing device positioned to receive the light at the secondary wavelength and configured to reduce the divergence of the light at the secondary wavelength, and an actuator operable to scan such light across a field-of-view (FOV).

According to other aspects, scanned beam systems are disclosed for forming an image from the light at the secondary wavelength generated by the photoluminescent light source. The image may be formed by scanning a beam of light at the secondary wavelength across a FOV or by scanning a beam of light at the secondary wavelength onto an image surface such as a display screen or a retina of a viewer's eye.

### BRIEF DESCRIPTION OF THE DRAWINGS

FIG. 1 is a graph of a wavelength spectrum of a down-converting photoluminescent material.

FIG. 2A is a schematic isometric view of a photoluminescent light source according to an embodiment.

FIG. 2B is a flow chart illustrating a method of operation for a photoluminescent light source according to an embodiment.

FIG. 3 is a schematic cross-sectional view of a photoluminescent light source having a reflecting layer disposed between the excitation light source and the photoluminescent material according to an embodiment.

FIG. 4 is a schematic cross-sectional view of a photoluminescent light source having a first reflecting layer disposed between the excitation light source and the photoluminescent material and a second reflecting layer disposed on an opposing side of the photoluminescent material according to an embodiment.

FIG. 5 is a schematic cross-sectional view of a photoluminescent light source having a photoluminescent material configured as an elongate structure according to an embodiment.

FIG. 6 is a schematic isometric view of a photoluminescent light source having a plurality of excitation light sources according to an embodiment.

FIG. 7 is a schematic view of a photoluminescent light source employing a photoluminescent optical fiber according to an embodiment.

FIG. 8A is a schematic view of a photoluminescent light source employing a photoluminescent optical fiber according to an embodiment.

FIG. 8B is a schematic cross-sectional view of a photoluminescent double clad optical fiber according to an embodiment.

FIG. 9 is a schematic view of a photoluminescent light source employing a particulate photoluminescent material according to an embodiment.

FIG. 10 is a schematic cross-sectional view of a photoluminescent light source employing a photoluminescent film structure according to an embodiment.

FIG. 11 is a schematic cross-sectional view of a photoluminescent light source employing a plurality of excitation light sources and a plurality of photoluminescent devices according to an embodiment.

FIG. 12 is a schematic cross-sectional view of a photoluminescent light source employing a beam splitter to alter the direction of the light emitted from the photoluminescent material according to an embodiment.

FIG. 13 is a schematic view of a scanned beam display employing a photoluminescent light source of FIGS. 2-12 according to an embodiment.

FIG. 14 is a schematic view of a scanned beam image capture system employing a photoluminescent light source of FIGS. 2-12 according to an embodiment.

### DETAILED DESCRIPTION OF THE EMBODIMENTS

Embodiments disclosed herein are directed to photoluminescent light sources which convert light at a primary wavelength to light at a selected secondary wavelength. In order to form an image from the light at the selected secondary wavelength, the converted light may be focused or collimated to form a beam, if appropriate, prior to scanning the light at the selected secondary wavelength to form the image or the light at the selected secondary wavelength may be directly scanned to form the image.

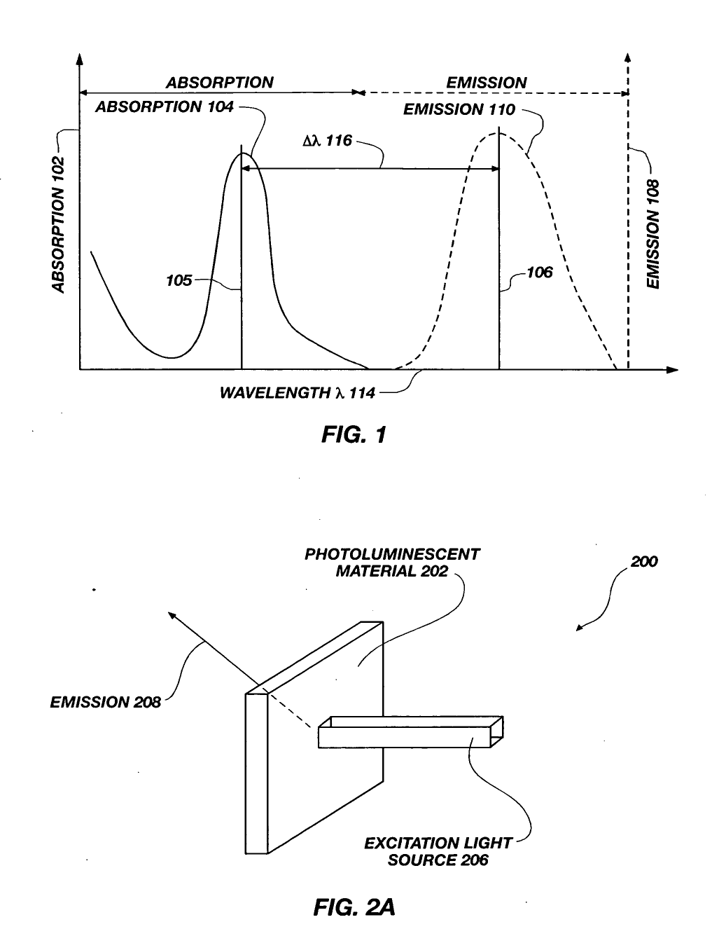

FIG. 1 shows a wavelength spectrum of a photoluminescent material. With reference to FIG. 1, a wavelength spectrum includes an absorption portion 104 and an emission portion 110. A magnitude of the absorption portion of the spectrum 104 is indicated on the left vertical axis 102 and a magnitude of the emission portion of the spectrum 110 is indicated on the right vertical axis at 108. The wavelength is plotted on the horizontal axis 114. The absorption portion of the spectrum 104 is centered on a peak wavelength 105, which is referred to as a “primary wavelength.” The absorption portion of the spectrum 104 may alternatively include a plurality or a broader range of primary wavelengths. The emission portion of the spectrum 110 is centered on a peak wavelength 106, which is referred to herein as a “secondary wavelength.” The emission portion of the spectrum 110 may alternatively include a plurality or broader range of secondary wavelengths. Typically, the magnitude of the emission portion of the spectrum 110 is less than the magnitude of the absorption portion of the spectrum 104. A photoluminescent material possessing absorption and emission spectrums of FIG. 1 will convert energy absorbed by the material, within the absorption portion 104, to an emission of energy characterized by the emission portion 110. The conversion of energy, occurring within the photoluminescent material, results in a wavelength shift as indicated nominally by the increase in wavelength ?? 116. The example of FIG. 1 shows a down-converting photoluminescent material wherein the primary wavelength is shorter than the secondary wavelength, i.e. the material converts down to a lower energy photon. Other materials, known as up-converting photoluminescent materials, exhibit a primary wavelength longer than the secondary wavelength, i.e. the material converts up to a higher energy photon. Photoluminescent materials employed in the embodiments disclosed herein may be up-converting or down-converting.

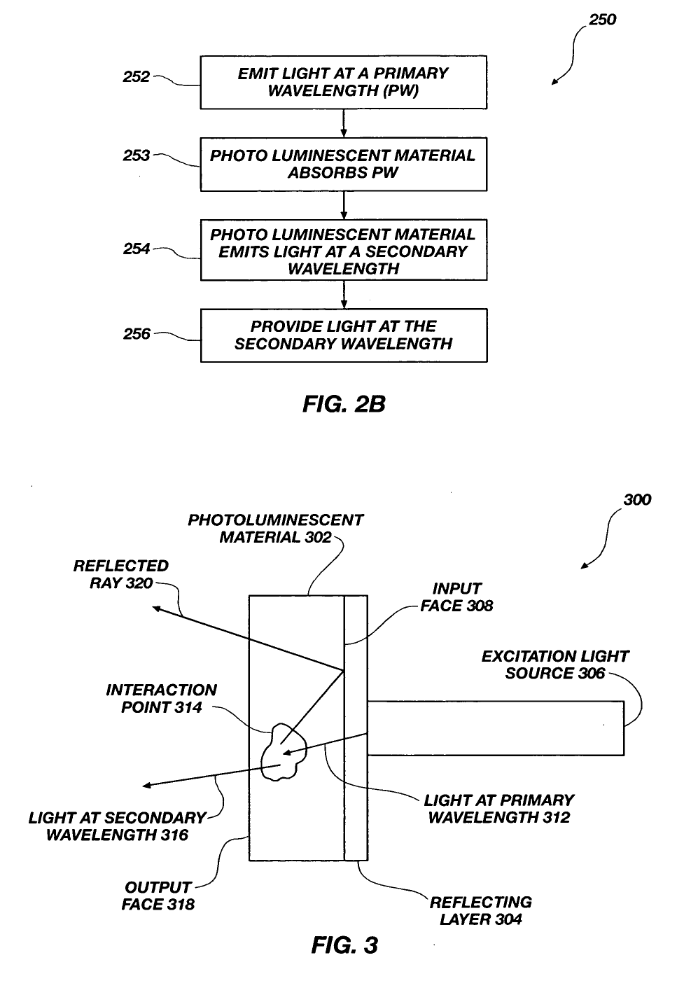

FIG. 2A shows a photoluminescent light source 200 according to an embodiment. The photoluminescent light source 200 includes a photoluminescent material 202 and an excitation light source 206. The excitation light source 206 of the photoluminescent light source 200 is operable to emit light at a primary wavelength. Various devices may be used for the excitation light source 206 such as a laser diode, which may emit light in the violet or ultraviolet wavelength range. Those of skill in the art will appreciate that the width in wavelength of an output spectrum of a light source will differ according to the light source. Reference to “a primary wavelength” can be conveniently associated with the dominant wavelength of the output spectrum of the excitation light source.

Examples of materials suitable for the photoluminescent material 202 include, but are not limited to, green emitting phosphors such as zinc sulfide doped with copper and aluminum (ZnS:Cu,Al), blue emitting phosphors such as (SrCaBa).sub.5Cl(PO.sub.4).sub.3:Eu, and red emitting phosphors such as Mg.sub.4FlGeO.sub.6:Mn. Fluorescent dyes such as coumarin, fluorescein, and rhodamine; nanoparticles (e.g., quantum dots) supported by or dispersed in liquids or solids; doped crystal solids such as neodymium doped yttrium aluminum garnet (Nd:YAG) (Y₃Al₅O₁₂:Nd); and doped glasses are other materials that may be suitable for the photoluminescent material 202. The photoluminescent material 202 may be of a type described in, for example; Shigeo Shionoya and William M. Yen, eds, PHOSPHOR HANDBOOK, CRC Press (1999); Wise, Donald L. et al., eds, PHOTONIC POLYMER SYSTEMS, Marcel Dekker (1998); and/or Berlman, Isadore B., HANDBOOK OF FLUORESCENCE SPECTRA OF AROMATIC MOLECULES, Academic Press (1965); all hereby incorporated by reference. Furthermore, if employed in scanned beam display applications, modulated scanned beam image capture applications, or other applications involving modulation of the light source; the photoluminescent material 202 may exhibit fluorescent or phosphorescent characteristics, consistent with the decay requirements necessitated by pixel duration (on-time) time with respect to displaying or capturing image data, or consistent with other system requirements for modulation. For some scanned beam display applications, the pixel on-time is desired to be approximately 10-20 nanoseconds. Thus, the photoluminescent material's persistence time may be selected to be approximately less than or equal to the required pixel on-time for a given display to prevent streaking or other undesirable display artifacts.

In operation, one or more primary wavelengths are absorbed by the photoluminescent material 202 and the photoluminescent material 202 emits an emission 208 at one or more secondary wavelengths. In one embodiment, the primary wavelength emitted by the excitation light source 206 is within a range of visible wavelengths, such violet. In other embodiments, the primary wavelength emitted by the excitation light source 206 is within the range of non-visible wavelengths, such as infrared, ultraviolet or approximately ultraviolet. Other primary wavelengths may be used alternatively or additionally.

In one embodiment, the photoluminescent material 202 is a photoluminescent material that has a cross-sectional area that is larger than the cross-sectional area of the output area of the excitation light source 206. For embodiments where excitation light source 206 is a laser diode, the photoluminescent material 202 may have a cross-sectional area larger than the output facet of the laser diode. In one embodiment, the photoluminescent material 202 is configured as a plate with generally parallel faces.

In a typical configuration, the emission 208 from the plate 202 is substantially omnidirectional or otherwise occurs over a solid angle that is larger than a solid angle over which light is emitted from the excitation light source 206. Accordingly, in order to form an image from the emission 208, the emission 208 may be collected using a focusing device such as a lens or another suitable optical device to form a beam of substantially collimated light that is subsequently scanned to form the image. When the luminance of light emitted from the photoluminescent material 202 is reduced by a ratio of the solid angle of the light emitted from the excitation light source 206 to the solid angle of the emission 208 (as well as by other loss processes), the light intensity is sufficient, especially compared to conventional light sources. For example, a commercially available 30 milliwatt laser diode may be used to excite various photoluminescent materials to emit approximately 9 milliwatts of light energy over a 4 pi solid angle, of which about 150 microwatts is collected over a smaller solid angle. The emission of 150 microwatts (more or less) is larger in comparison to the emission power achieved by edge emitting LEDs over a similar solid angle which is typically about 0.5 microwatts.

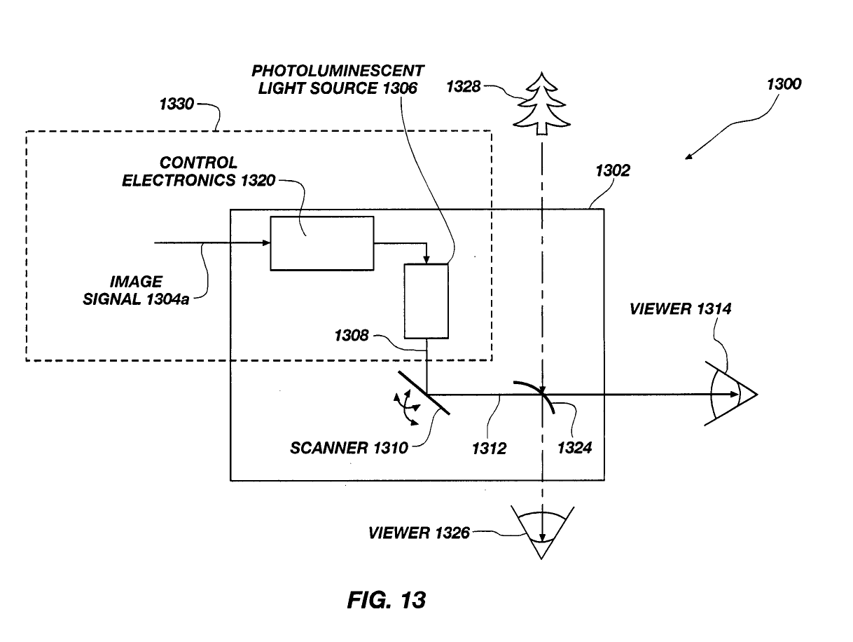

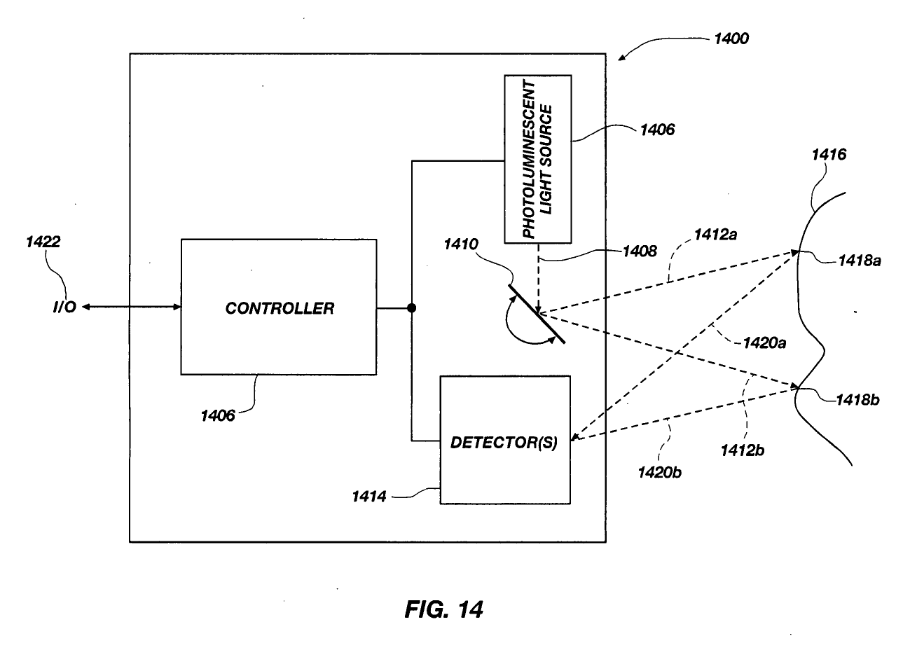

The flow diagram 250 of FIG. 2B illustrates a method of operation for a photoluminescent light source according to an embodiment. In act 252, the excitation light source 206 emits light at a primary wavelength. In act 253, the light emitted from the excitation light source 206 is absorbed by the photoluminescent material 202. In act 254, light is emitted from the photoluminescent material 202 at a secondary wavelength which may be, for example, at a longer or shorter wavelength than the primary wavelength (act 252). In act 256, the light emitted by the photoluminescent material 202 is emitted as a beam. The beam may be used in a range of light beam applications such as a scanned beam display (which will be described in more detail in conjunction with FIG. 13), a scanned beam image capture device (which will be described in more detail in conjunction with FIG. 14), an electrophotographic printer exposure system, a light beam pointer, a wide-beam light source for an LCOS, mirror array or other display system, or in other systems.

FIG. 3 shows a photoluminescent light source 300 that utilizes a reflecting layer according to another embodiment. A reflecting layer 304 is disposed between an input face 308 of photoluminescent material 302 and the excitation light source 306. The reflecting layer 304 and the photoluminescent material 302 are located in the optical path of the excitation light source 306. In one embodiment, the excitation light source 306 emits light at a primary wavelength 312 that is transmitted through the wavelength selective reflecting layer 304, and causes an interaction point 314 with the photoluminescent material 302. The primary wavelength 312 is transmitted through the wavelength selective reflective layer and is absorbed during the interaction point 314. Light at a secondary wavelength 316 is emitted by the photoluminescent material 302 resulting in secondary wavelength 316 emanating from the output face 318 of the photoluminescent material 302.

The emission of the secondary wavelength may be enhanced by the addition of the reflecting layer 304. In one embodiment, the material characteristics of the reflecting layer 304 that is disposed between the excitation light source 306 and the input face 308 of the photoluminescent material 302 is designed to selectively transmit light at the primary wavelength 312 and to reflect light selectively at the secondary wavelength as indicated by reflected ray 320. The reflected ray 320 represents light emitted at the secondary wavelength 316 by the photoluminescent material 302 that is reflected by the reflecting layer 304 causing the reflected ray to exit the output face 318. The addition of the reflecting layer 304 results in an increase in the amount of secondary wavelength energy emitted from the output face 318 of the photoluminescent material 202. In some cases, the amount of secondary wavelength energy output by the photoluminescent material 202 is doubled in comparison to when no reflecting layer 304 is present.

The reflecting layer 304 may be formed on or applied to the photoluminescent material 302, as shown in FIG. 3. Alternatively, the reflecting layer 304 may be spaced apart from the input face 308. Additionally, the excitation light source 306 may be located in direct contact with the reflecting layer 304 or the excitation light source 306 may be located a distance away from the reflecting layer 304 consistent with design parameters of a particular device.

In one embodiment, the reflecting layer 304 may be a distributed Bragg reflector that is formed of alternating dielectric layers having different respective indices of refraction. The distributed Bragg reflector is designed to pass a particular wavelength or range of wavelengths and to reflect other wavelengths. For example, in one embodiment, the reflecting layer 304 is a distributed Bragg reflector and transmits violet or ultraviolet light and will reflect red, green or blue light. Examples of materials for the reflecting layer 304 include multilayered dielectric films made from alternating layers titanium dioxide (TiO₂) and silicon dioxide (SiO₂) or another suitable composition.

In another embodiment, the reflecting layer 304 may be a broad band reflector with an aperture formed therein enabling transmission of the light at the primary wavelength 312 therethrough. The relatively small size of the aperture compared to the range of emission angles of the wavelength converting photoluminescent material 302 results in a relatively large proportion of the emission at the secondary wavelength 316 generated therefrom in the general direction of the incoming excitation light at the primary wavelength to miss the aperture and be reflected forward as illustrated by reflected ray 320. Many suitable broad band reflectors are known to the art, including metals and chirped dielectric stacks. In this embodiment, the reflecting layer 304 may be reflective to light at the primary wavelength 312 and the secondary wavelength 316 because the aperture formed in the reflecting layer 304 enables the light at the primary wavelength 312 to pass therethrough.

In yet another embodiment, the reflecting layer 304 is curved in the shape of a parabolic or spherical reflector. The focal surface of the curved reflecting layer 304 is located so that the point of wavelength conversion in the photoluminescent material 302 is positioned on or proximate the focal surface. By locating the point of wavelength conversion on or proximate the focal surface, the curved reflecting layer 304 substantially collimates the light at the secondary wavelength 316 emitted from the photoluminescent material 302 back toward the curved reflecting layer 304 without the need for a separate focusing device such as a lens.

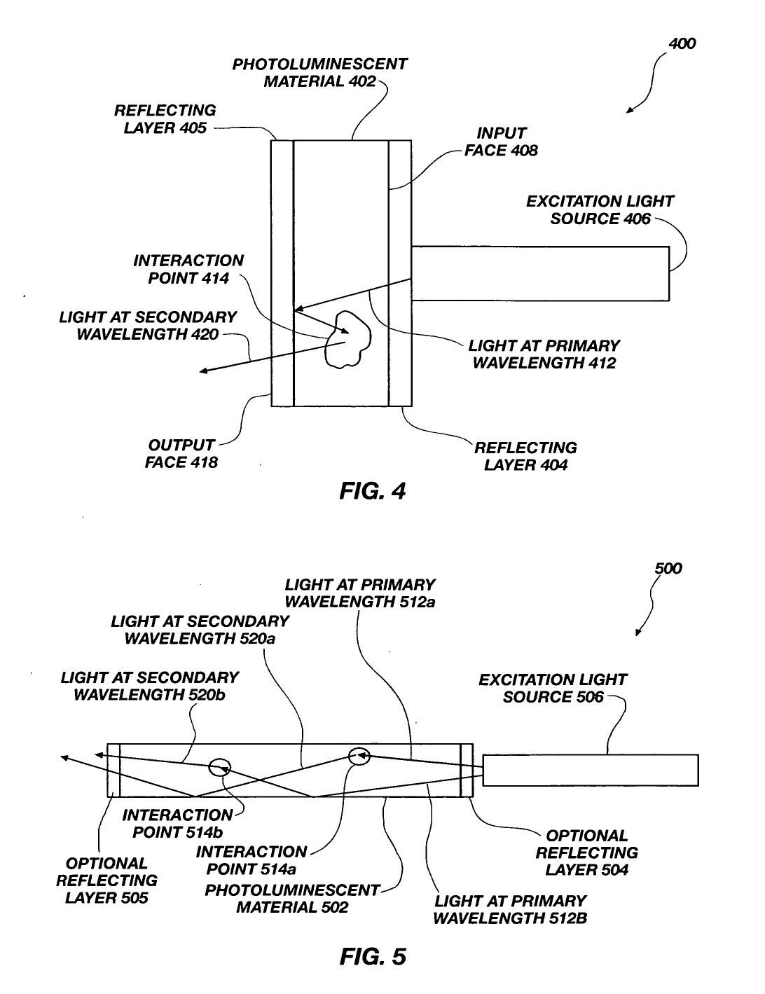

FIG. 4 shows a photoluminescent light source 400 that is structurally similar to the photoluminescent light source 300 of FIG. 3 according to an embodiment. The photoluminescent light source 400 differs from the photoluminescent light source 300 in that two reflecting layers are disposed on opposing sides of the photoluminescent material 402. A reflecting layer 404 is disposed between an input face 408 of photoluminescent material 402 and the excitation light source 406. The reflecting layer 404 and the photoluminescent material 402 are located in the optical path of the excitation light source 406. Another reflecting layer 405 that is at least reflective to light at the primary wavelength 412 is disposed on an output face 414 of the photoluminescent material 402. In operation, the excitation light source 406 emits light at the primary wavelength 412. In one or more embodiments, the primary wavelength is part of the visible spectrum, such as violet at a wavelength of 408 nanometers (nm). In other embodiments, the primary wavelength emitted from the excitation light source 406 is in the ultra-violet band, for example at a wavelength of 380 nm, or the infrared, for example near a wavelength of 780 nm.

Light emitted from the excitation light source 406 at the primary wavelength 412 is transmitted through the reflecting layer 404, and interacts with and is absorbed by the photoluminescent material 402, as represented by interaction point 414. During the interaction, the photoluminescent material 402 emits light at a secondary wavelength 420 which may be at a higher wavelength, as indicated generally in FIG. 1 by ?? 116, or a lower wavelength depending on the whether the photoluminescent material 402 is an up-converting or down-converting photoluminescent material.

In one embodiment, the reflecting layer 404 is selectively reflective and formed from a material that is transmissive to light at the primary wavelength 412 and reflective to light at the secondary wavelength 420. In another embodiment, the reflecting layer 404 may be formed with a structure such as an aperture that admits light at the primary wavelength 412 and reflects light across a broad range of wavelengths including light at the primary wavelength 412 and the secondary wavelength 420. The reflecting layer 404 provides the functionality described above in conjunction with FIG. 3, such as preventing light emitted by the photoluminescent material at the second wavelength from passing out of the input face 408. Instead, such light is reflected off of the reflecting layer 404 and is redirected to the output face 418 of the photoluminescent material 402.

The reflecting layer 405 is disposed adjacent the output face 418 opposite the input face 408 to intercept light emitted from the photoluminescent material 402. In one embodiment that may be employed in combination with any of the embodiments for the reflecting layer 404, the reflecting layer 405 is selectively reflective and formed of a material that reflects light at the primary wavelength 412 and transmits light at the secondary wavelength 420. In another embodiment that may be employed in combination with any of the embodiments for the reflecting layer 404, the reflecting layer 405 may be formed to have a structure that substantially prevents any light (both light at the primary wavelength 412 and secondary wavelength 420) from exiting the portion of the output face 418 opposite the entrance location for the excitation light at the primary wavelength 412 (i.e., the aperture of a broad band reflecting layer 404), but allows light to exit from regions of the output face 418 that are not covered by the reflecting layer 405. This structure blocks any light at the primary wavelength 412 that is not absorbed by the photoluminescent material 402 and light at the secondary wavelength 420 generated by the photoluminescent material 402 that is directed onto the structure. Such a structure may, for example, include a patterned reflective area centered on and aligned with the portion of the input face 408 that the light at the primary wavelength 412 enters through, and sized to correspond to the numerical aperture of the excitation light source 406. Such an alternative reflecting layer 405 may be formed, for example, from metals or chirped dielectric reflectors as is known to the art.

In yet another embodiment, the reflecting layer 404 is curved in the shape of a parabolic or spherical reflector as previously described with respect to the reflecting layer 304 of FIG. 3. However, in addition to substantially collimating the light at the secondary wavelength 420 emitted from the photoluminescent material 402 back toward the curved reflecting layer 404, the curved reflecting layer 404 may also substantially collimate any of the light at the secondary wavelength 420 reflected back from the reflecting layer 405, if applicable.

The reflecting layer 405 contributes to an increased conversion of primary wavelength light energy to secondary wavelength light energy by doubling the path length of the primary wavelength light energy within the photoluminescent material 402. Collectively, the reflecting layers 404 and 405 enable the light at primary wavelength light to traverse the photoluminescent material multiple times. Thus, the interaction path length of the primary wavelength light energy with the photoluminescent material 402 is increased, consequently increasing absorption of the primary wavelength light energy by the photoluminescent material 402.

As described above, the reflecting layer 405 reflects light at the primary wavelength 412 back toward the light source 406. Thus, the reflecting layer 405 prevents light at the primary wavelength 412 from being collected by and delivered to a display or other apparatus (not shown) that could harm a user who views an image with the light energy emanating from the output face 418.

As with the reflecting layer 404, the reflecting layer 405 may be formed on or applied to the photoluminescent material 402. Alternatively, the reflecting layer 404 may be located a distance from the output face 418. In one embodiment, the reflecting layer 405 may be a distributed Bragg reflector that is formed of alternating dielectric layers having different respective indices of refraction. The distributed Bragg reflector is designed to be transmissive to a particular wavelength or range of wavelengths and to reflect other wavelengths. For example, in one embodiment, the reflecting layer 405 is a distributed Bragg reflector that reflects violet or ultraviolet and passes red, green or blue.

FIG. 5 shows a photoluminescent light source 500 according to an embodiment. The conversion of light at the primary wavelength energy to light at the secondary wavelength energy may be enhanced by the geometric configuration of photoluminescent material 502. In FIG. 5, the photoluminescent material 502 is configured as an elongate structure. In one embodiment, the elongate structure of the photoluminescent material 502 is cylindrical having, for example, a length of approximately 150 microns and a diameter of approximately 3 microns. Light source 506 emits light 512a and 512b at a primary wavelength that interacts with the photoluminescent material 502 causing absorption of the primary wavelength energy and emission of light 520a and 520b at a secondary wavelength. The cylindrical geometry facilitates guiding light 512b at the primary wavelength along the longitudinal extent of the cylinder, as shown in FIG. 5. Light at the primary wavelength 512b results in emission of light at the secondary wavelength 520b at interaction point 514b. Similarly, the cylindrical geometry facilitates guiding light 520a at the secondary wavelength following interaction point 514a. By employing a photoluminescent material with an elongated structure, photoluminescent materials with weak primary absorption may be used, while still generating emission of a sufficient magnitude to be useful. Although the excitation light source 506 is shown in FIG. 5 with a standoff provided, in some embodiments the excitation light source 506 may be butt coupled to the photoluminescent material 502. As with the photoluminescent light sources 300 and 400, the photoluminescent light source 500 may optionally include reflecting layers 504 and 505, which may be formed from the same materials and function similarly to the reflecting layers 304, 305, 404, and 405. The circumference of cylinder 502 may optionally be treated with a reflective layer. Alternatively, there may be an index of refraction difference between the cylinder and the volume outside the cylinder to provide reflection at the cylinder walls. In some embodiments, a cladding material may be disposed circumferentially to the cylinder to guide rays along the longitudinal axis of the cylinder. Alternatively, the cylinder may be formed as an elongate rectangular, hexagonal, etc. solid.

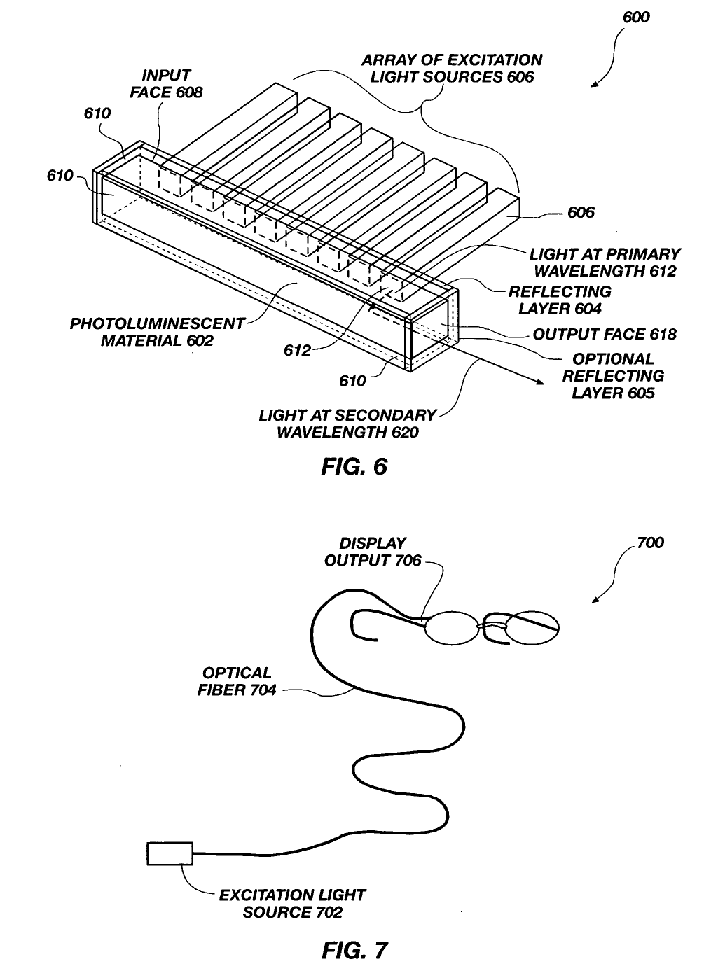

FIG. 6 shows a photoluminescent light source 600 that includes an array of individual excitation light sources 606 according to an embodiment. As with the photoluminescent light sources 300, 400, and 500, the photoluminescent light source 600 includes a reflecting layer 604 disposed between an input face 608 of photoluminescent material 602 and the array of excitation light sources 606, and an optional reflecting layer 605 disposed adjacent to output face 618 of the photoluminescent material 602. The photoluminescent light source 600 further includes on other faces of the photoluminescent material 602, except the output face 618, reflecting layers 610 that reflect light at the secondary wavelength and may, additionally, reflect light at the primary wavelength. If the reflecting layers 610 reflect light at the primary wavelength, light at the primary wavelength is confined within the volume of photoluminescent material 602 enabling further conversion of light energy to the secondary wavelength. Reflection of light at the secondary wavelength by the reflecting layers 604 and 610 guides such light out the output face 618 and further enhances the intensity of light leaving the output face 618.

Optionally, reflecting layers on surfaces other than the output face 618 may be formed to be broadly reflecting such as to reflect a range of wavelengths including the primary wavelength and the secondary wavelength. When such a reflecting surface is used on the input face of photoluminescent material 602, apertures are formed therein and the excitation light sources aligned therewith to admit excitation light.

In operation, the array of excitation light sources 606 illuminates the photoluminescent material 602 on the input face 608. Light at the primary wavelength is emitted by the excitation light sources 606 and interacts with the photoluminescent material 602. For clarity in FIG. 6, only the light emitted from one excitation light source 602 is shown. Light at the primary wavelength 612, which interacts with the photoluminescent material 602, results in absorption of the primary wavelength and emission of light at a secondary wavelength 620. The reflecting layers 604 and the reflecting layers 610 applied to all other faces of the photoluminescent material 602 confines and guides the light at the secondary wavelength 620 in the direction indicated by the arrow associated with 620 so that it is emitted from the output face 618.

In an alternative embodiment, excitation light sources 606 may be selected to emit a plurality of primary excitation wavelengths, each of which undergoes conversion to a corresponding one of a plurality of secondary output wavelengths by a photoluminescent material 602 having a capability to convert a plurality of excitation wavelengths to a corresponding plurality of output wavelengths. The number of excitation light sources 606 corresponding to each color may be selected to accommodate differences in excitation light source output power, wavelength conversion efficiency, system efficiency differences, and human eye sensitivity, for example, to arrive at a desired color balance of the entire photoluminescent light source 600. According to some embodiments, excitation light sources 606 may be modulated individually or as a group to provide a desired secondary wavelength output power and/or, optionally, wavelength mixture (color balance).

FIG. 7 shows a photoluminescent light source located a distance from a display according to an embodiment. An excitation light source 702 is operable to emit light at a primary wavelength, which is modulated to contain image information, into a photoluminescent optical fiber 704. As described above in conjunction with any of the aforementioned embodiments, the primary wavelength may be within the non-visible spectrum or within the visible spectrum, such as violet light. Light at the primary wavelength interacts with the photoluminescent core of the optical fiber 704 resulting in light emitted at a secondary wavelength. The secondary wavelength may be within the visible spectrum and may correspond to any one of various visible colors, such as red, green or blue or another color. The optical fiber 704 guides and transmits the light at the secondary wavelength to a display 706. Thus, the optical fiber 704 may function to optically couple light to the display output 706, and also as the photoluminescent light source for the display output 706.

In one embodiment, the excitation light source 702 illuminates three different optical fibers 704. Each of the optical fibers 704 may include a different photoluminescent material, each photoluminescent material having a characteristic to emit a different color of light (secondary wavelength) in response to light emitted from the excitation light source 702 at the primary wavelength. For example, one optical fiber generates light at a secondary wavelength that is red, another optical fiber generates light at a secondary wavelength that is green and a third optical fiber generates light at a secondary wavelength that is blue. In one embodiment, full color image data from the light supplied by the three optical fibers is collected with a single optical element, such as a lens, and the optical beam is scanned for viewing by a user at a display output 706.

In another embodiment, more than three fibers having respective emission wavelengths are used to provide an expanded range of colors for the image supplied to a display output for viewing by a user. The secondary wavelengths of the emissions can be selected according to known spectral combination techniques to provide a desired perceived color spectrum that may be broader than that achieved or achievable by a system employing only three secondary emission wavelengths. In yet another embodiment, n fibers, some of which may emit light at common secondary wavelengths, may be combined to simultaneously produce more than one effective scan line, thereby increasing the effective scan rate of a scanner used for a scanned beam display by n.

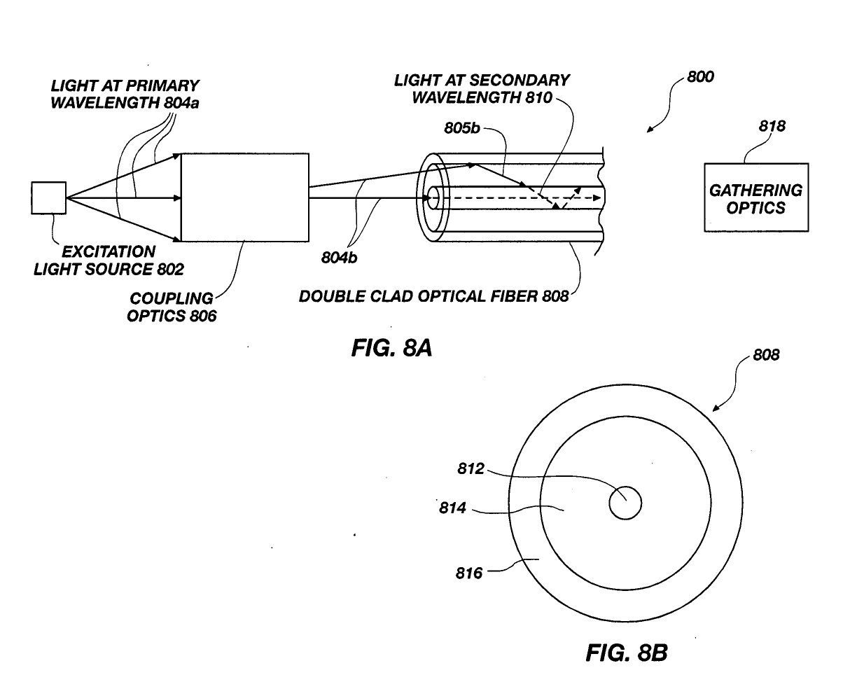

In one embodiment, the optical fiber 704 may be configured as a single clad optical fiber having a photoluminescent core and a suitable lower index cladding. In another embodiment, the optical fiber 704 may be a double clad fiber. FIG. 8A shows a photoluminescent light source 800 utilizing a double clad optical fiber 808 according to hone embodiment. An excitation light source 802 emits light at a primary wavelength 804a. The light at the primary wavelength 804a is collected and coupled (804b) to the double clad optical fiber 808 by coupling optics 806. Coupling optics 806 are optical elements that may include a lens or lenses, prisms, mirrors, facets, or combinations thereof that are arranged to efficiently couple light into the double clad optical fiber 808. The coupling optics 806 may be configured to conserve the product of numerical aperture and area by optimally coupling from a numerical aperture and area of the double clad fiber 808 to a numerical aperture and area of the excitation light source 802.

A cross-sectional view of the double clad optical fiber 808 is shown in FIG. 8B. In one embodiment, the double clad optical fiber 808 includes a core 812 formed of a photoluminescent material surrounded by an inner cladding 814 and an outer cladding 816 surrounding the inner cladding 814. The core 812 may include any of the aforementioned photoluminescent materials. The inner cladding 814 has an index of refraction greater than an index of refraction of the outer cladding 816, and less than an index of refraction of the photoluminescent core 812.

With continued reference to FIGS. 8A and 8B, in operation, the coupled primary wavelength light energy 804b is injected predominately into the inner cladding 814 and confined therein by the lower index outer cladding 816. The primary wavelength light energy is progressively absorbed by the core 812 as the light at the primary wavelength 805b propagates along the length of the double clad optical fiber 808. The absorption of the light at the primary wavelength by the core 812 results in the emission of light at the secondary wavelength 810 by the core 812, which is confined in the core 812 and guided along the length thereof by the lower index inner cladding 814. The light at the secondary wavelength 810 is output from an end of the optical fiber 808. If the light at the secondary wavelength 810 output from the end of the optical fiber 808 is collimated to a sufficient extent, the light at the secondary wavelength 810 may be scanned to form an image without the need for using a separate focusing device such as a lens to form a beam. However, if desired, a focusing device may be used to improve collimation of the light at the secondary wavelength 810 output from the optical fiber 808. In either case, the light at the secondary wavelength 810 output from the end of the optical fiber 808 may be collected by gathering optics 818 (which may include a focusing device) oriented to receive the emitted light at the secondary wavelength 810 and configured to produce a desired optical output at the secondary wavelength 810.

In another embodiment for the double clad optical fiber 808, the core 812 is formed of an optically transparent material, such as glass, and the inner cladding 814 is formed of a photoluminescent material. The inner cladding 814 may include any of the aforementioned photoluminescent materials. In operation, the coupled light at the primary wavelength 804b emitted from the excitation light source 802 and injected into the core 812 couples evanescently with the inner cladding 814 to produce light at the secondary wavelength 810. The light at the secondary wavelength 810 produced by the photoluminescent inner cladding 814 couples evanescently back into the core 812 and is guided by the inner cladding 814 along the length of the optical fiber 808.

In one embodiment, the light at the secondary wavelength is guided by the optical fiber 808 and emitted therefrom to a scanner of a display device, such as the display 706 (FIG. 7). In another embodiment, the emitted light at the secondary wavelength 810 is guided by the optical fiber 808 to a scanner such as the scanners described below in conjunction with FIGS. 13 and 14.

In other embodiments, the light sources shown in the preceding figures, such as FIG. 2A and FIGS. 3 through 7 may be used for the excitation light source 802. However, other configurations of light sources (not shown) may be used for the light source 802 with suitable coupling optics 806. For example, a horizontal or vertical array of light sources may be used for the light source 802 with suitable coupling optics. Coupling optics may also be used to focus light at the primary wavelength onto a photoluminescent particle or film.

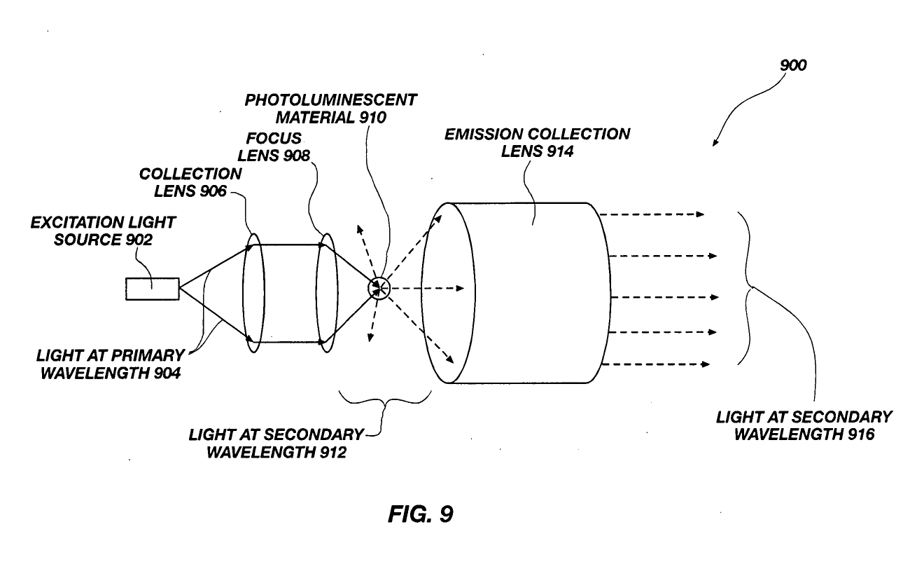

FIG. 9 shows a photoluminescent light source 900 utilizing a photoluminescent material 910 in the shape of a particle according to an embodiment. An excitation light source 902 emits light at a primary wavelength as previously described. The light energy emitted at the primary wavelength is collected by collection lens 906 and is focused by optional focus lens 908 onto a photoluminescent material 910. The photoluminescent material absorbs light at the primary wavelength and emits light at a secondary wavelength 912.

In addition to the previously described photoluminescent materials, various materials may be used for the photoluminescent material 910. In one embodiment, a fluorescent material such as perylene dissolved in a solvent of cyclohexane is incorporated into a capsule and is illuminated with light at the primary wavelength 904 resulting in absorption and then an emission of light at the secondary wavelength 912 due to the optical characteristics of the fluorescent dye contained in the capsule. In another embodiment, the photoluminescent material 910 is made from the laser dye Pyrromethene 597, which may be dissolved in ethanol. In another embodiment, a dye polymer system is used to locate photoluminescent particles whose size is on the order of 0.5 micron in a polymer carrier. In other embodiments, the particles are held in a transparent solid, such as a gel matrix, to position the particles relative to the incident light at the primary wavelength and to provide for heat removal. In one embodiment, single crystals of zinc sulfide doped with copper and aluminum (ZnS:Cu,Al) are used as the photoluminescent material 910. In other embodiments, the photoluminescent material 910 may include a dye polymer such as IR 125 (Exciton Inc. Dayton, Ohio) configured into a film of approximately 0.5 micron thickness, at a suitable concentration, to absorb approximately 90 percent of the incident light at the primary wavelength.

In one embodiment, a violet or ultraviolet light source, such as a laser diode is used for excitation light source 902 and light at the primary wavelength 904 is focused by the collection optics 906 and/or the focus lens 908 onto a spot of approximately 0.5 micron in diameter. In various embodiments, conversion efficiency of light from the primary to the secondary wavelength may be increased by using lenses (such as 906 and/or 908) to focus the light at the primary wavelength 904 to a spot size that is smaller than the spot size of the light source 902, thereby increasing the numerical aperture of the light at the primary wavelength 904.

An emission collection lens 914 collects the light emitted at the secondary wavelength 912. The emission collection lens 914 may substantially collimate such light to form a beam or may provide all or a portion of the focusing.

The beam of light at the secondary wavelength is incorporated in a display, as previously described, and as is further described below in conjunction with FIGS. 13 and 14. In one embodiment, light at the primary wavelength 904, emitted from a violet light source 902, is focused to a spot of approximately 0.5 micron on the photoluminescent material 910. If the photoluminescent material 910 is formed of, for example, a single crystal of ZnS:Cu,Al having a particle size of about 0.5 micron and the light at the secondary wavelength 912 is collected over an f/1 cone, a geometrical collection factor of 1/12 results. Based on the geometrical conversion factor of 1/12, a 30 milliwatt violet laser diode used for the light source 902 results in a 2.5 milliwatt power level for light emitted at the secondary wavelength. A 2.5 milliwatt power level represents a significant increase in optical power output relative to conventional light sources as edge emitting LEDs, which have typical optical power outputs of 0.5 microwatts.

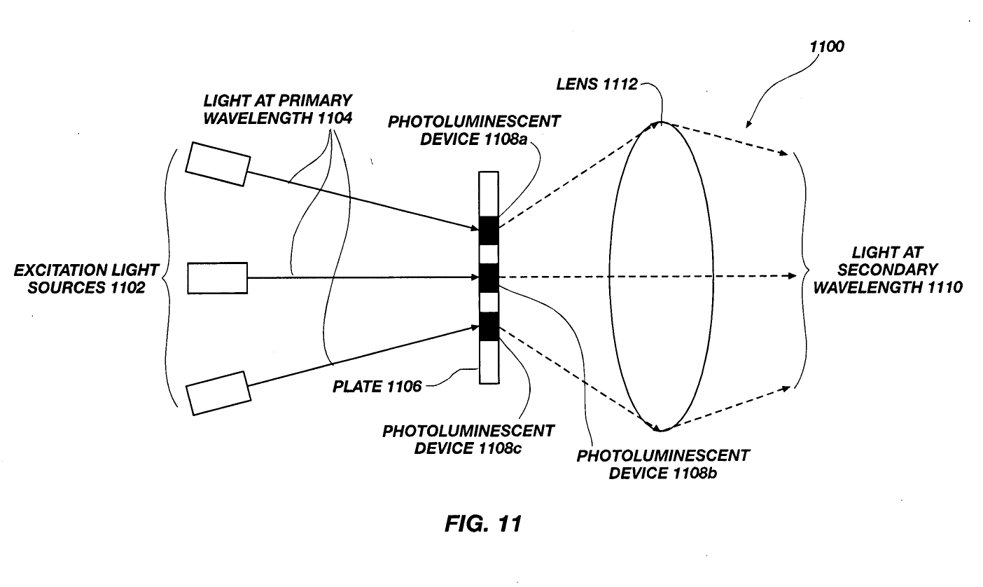

In various embodiments, nanoparticles such as quantum dots may be used to control a color of the light emitted by the photoluminescent material 910. Quantum dots may be structured to emit light at shorter secondary wavelengths (nearer the blue end of the visible spectrum) and or at longer secondary wavelengths (nearer the red end of the visible spectrum). Typically, the size of the quantum dot will correspond to the wavelength, so that smaller dots emit at shorter wavelengths. In various embodiments, suitably structured sized quantum dots are configured into color selectable photoluminescent light sources that emit light at selected secondary wavelengths such as, for example, red, green, and blue light. In one embodiment, a multicolor photoluminescent light source is configured into the system of FIG. 11 utilizing the light source described in conjunction with FIG. 9.

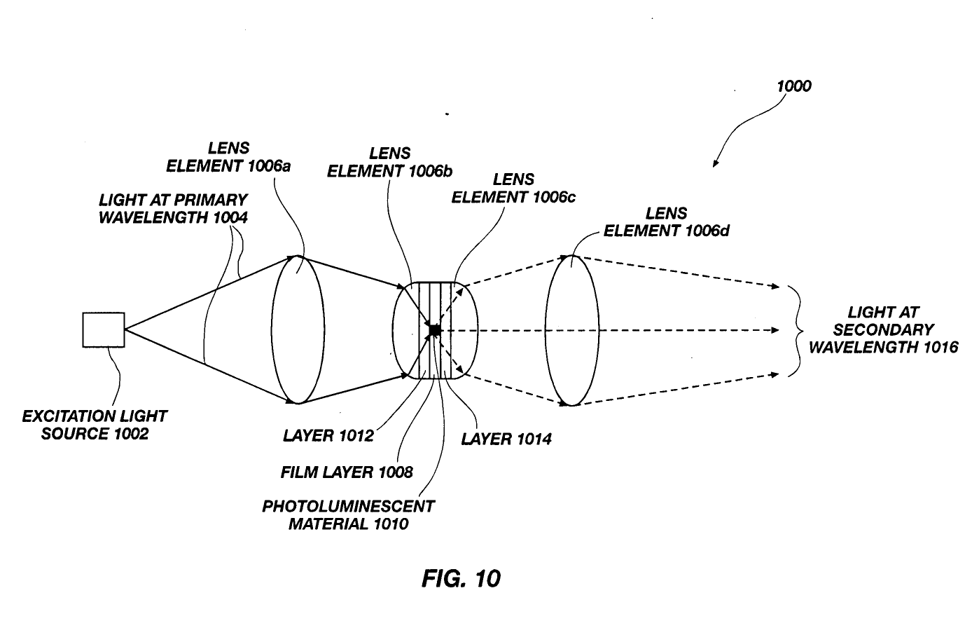

FIG. 10 shows a photoluminescent light source 1000 having a photoluminescent material 1010 incorporated into a film according to an embodiment. An excitation light source 1002 emits light at a primary wavelength 1004. The light at the primary wavelength 1004 is collected and focused by lens element 1006a onto film layer 1008. Optional optical lens element 1006b that is located adjacent to the film layer 1008 may be used to focus the light energy onto the film layer 1008 depending on a particular design of light source, considering such factors as a desired size of the photoluminescent light source, photoluminescent material characteristics, etc.

In one embodiment, a photoluminescent film is made using dyes, such as those described above, that are used for dye lasers. If the dye is used at a high concentration, then a high absorption of light at the primary wavelength is achieved with a short interaction length, which permits the use of a thin film for film layer 1008. In another embodiment, a photoluminescent film is made by depositing a film of phosphorescent material by vapor deposition. In yet another embodiment, a photoluminescent film is made using an organic dye in a polymer medium. In yet another embodiment, an epitaxial layer grown on a substrate, such as a semiconductor substrate, is used for the photoluminescent film layer 1008. In one embodiment, a gallium nitride (GaN) epitaxial layer is provided which yields green or blue light at the secondary wavelength depending on the composition of the GaN layer. In yet another embodiment, a film is made by incorporating nanoparticles, such as quantum dots into a host material. Photoluminescent films may be positioned such that light at the primary wavelength 1004 either illuminates the film 1008 across its surface or on its edge (surface pumped or edge pumped).

As described above in conjunction with the aforementioned embodiments, additional layers may be disposed on either side of the photoluminescent layer 1008 to selectively reflect and pass various wavelengths. In one embodiment, a layer 1012 is disposed between the light source 1002 and the film layer 1008 that transmits light at the primary wavelength and reflects light at the secondary wavelength. Another layer 1014 is disposed to intercept light emitted from the film layer 1008 at the secondary wavelength. In one embodiment, the layer 1014 reflects light at the primary wavelength and passes light at the secondary wavelength. Taken together, the layers 1012 and 1014 are configured to enhance the conversion of light at the primary wavelength to light at the secondary wavelength as described above in conjunction with the aforementioned embodiments.

As described above, the emission of light by photoluminescent materials is typically omnidirectional or isotropic. Therefore, collection of light emitted at the secondary wavelength 1016 may be enhanced in various embodiments, by a collection optic, such as a lens element 1006c, a lens element 1006d, or both. Optional lens elements 1006c and 1006d substantially collimate the light at the secondary wavelength 1016 to form a beam and may provide an increase in a luminous intensity of light provided to a display (not shown) by the system described in 1000.

FIG. 11 shows a photoluminescent light source 1100 having a plurality of photoluminescent devices 1108a-1108c according to an embodiment. A plurality of excitation light sources 1102 emit light at a primary wavelength 1104. As described above, the primary wavelength of the light sources 1102 may be outside the visible spectrum such as ultra violet, or within the visible spectrum such as violet. A plate or other suitable structure that supports photoluminescent devices 1108a, 1108b, and 1108c is positioned in the optical path of light at a primary wavelength 1104. In the embodiment shown in FIG. 11, three individual photoluminescent devices 1108a-1108c are depicted, however, more than or less than three photoluminescent devices may be used.

Photoluminescent devices are, in various embodiments, the photoluminescent materials used optionally with the various structures described in the preceding figures, such as but not limited to, photoluminescent materials, (sheets, cylinders, cubes, etc.), photoluminescent particles (and associated matrix materials), photoluminescent films, etc. A photoluminescent device may be used with or without the associated layers that filter light as described above in conjunction with the preceding figures. In various embodiments, a first photoluminescent device, such as a photoluminescent device 1108a is made utilizing one technique, such as the photoluminescent particle described above in conjunction with FIG. 9, and another photoluminescent device 1108b is made utilizing the photoluminescent film described in conjunction with FIG. 10.

The photoluminescent devices 1108a, 1108b, and 1108c are located proximate to one another so that a single collection optic, such as lens 1112, may be used to collect light emitted from the array of photoluminescent devices 1108a-1108c. Lens 1112 substantially collimates light at the secondary wavelength 1110 to form a beam and transmits such light to a display for viewing by a user. Thus, if the photoluminescent devices 1108a-1108c provide red, green, and blue light, (or an alternate mixture of primary colors) a full color image can be formed. In one embodiment, a display utilizes a scanner to scan one or more beams of light at secondary wavelengths that can be viewed by a user as described above in the preceding figures and below in conjunction with FIGS. 13 and 14. In one example of simplification over existing optical systems, the multicolored photoluminescent light source described herein can produce selectively colored light without an optical combiner and alignment processes that are typically employed to co-locate LED images.

In various embodiments, each photoluminescent device 1108a, 1108b, and 1108c may emit light at the same or different secondary wavelengths. A multi-colored photoluminescent light source is made in an embodiment configured with photoluminescent devices that emit light at different secondary wavelengths, such as secondary wavelengths corresponding to red, green, and blue light. In another embodiment, two or more of the photoluminescent devices 1108a, 1108b, and 1108c emit light at the same secondary wavelength, which may be used to increase the line scan rate of a scanner used in a scanned beam display. For example, if four photoluminescent devices are used the line scan rate of a scanner is increased by four for a given actual scanning frequency of the scanner.

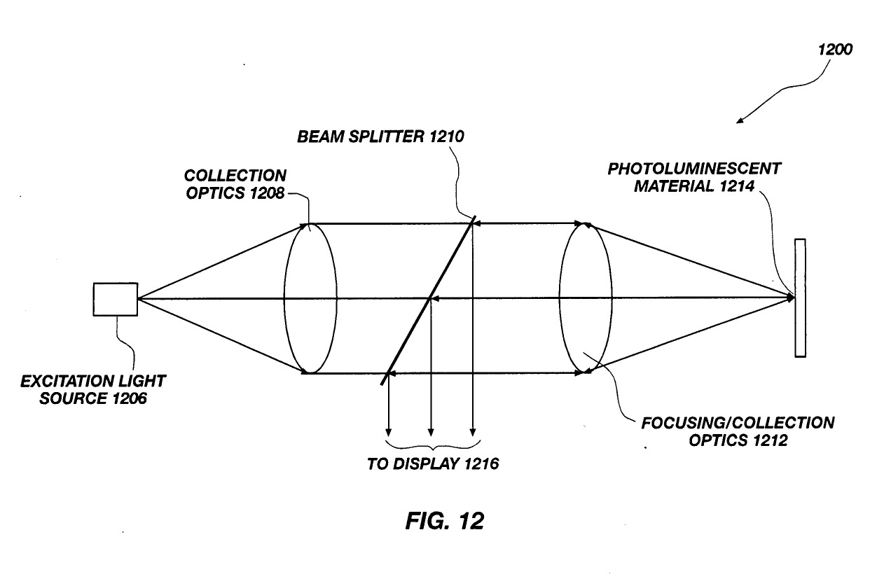

FIG. 12 shows a photoluminescent light source 1200 utilizing a beam splitter according to an embodiment. An excitation light source 1206 emits light at a primary wavelength that is collected by collection optics 1208 and focused by focusing/collection optics 1212 onto a photoluminescent material 1214. The photoluminescent material 1214 emits light at a secondary wavelength that is collected by focusing/collection optics 1212 and directed by a beam splitter 1210 to a display for viewing by a user at 1216. The beam splitter 1210 may be located and positioned between the collection optics 1208 and the focusing/collection optics 1212, and transmits light at the primary wavelength and reflects light at the secondary wavelength. The focusing/collection optics 1212 substantially collimate the light at the secondary wavelength to form a beam.

As described above in conjunction with the aforementioned embodiments, light emitted by the light source, at the primary wavelength, may be in the non-visible portion of the spectrum such as ultraviolet or within the visible portion of the spectrum such as violet. In one embodiment, the beam splitter 1210 passes violet light and reflects red light. Photoluminescent materials may be chosen for use in the photoluminescent material 1214 that emit light at various secondary wavelengths.

Photoluminescent materials may be positioned at discrete locations within 1214 to provide a plurality of photoluminescent devices that are separately addressed by individual light sources emitting primary wavelength light energy, such as the plurality of excitation light sources shown in FIG. 11. In one embodiment, locating multiple photoluminescent devices within the photoluminescent material 1214 permits absorption of the primary wavelength light energy and emission of secondary light energy of different colors by the respective photoluminescent devices. Accordingly, a multicolored photoluminescent light source is created that permits multicolored image data to be sent to a display 1216. In another embodiment, multiple photoluminescent devices are used that emit the same color secondary wavelength light energy in order to increase a line rate of a scanner.

FIG. 13 shows a scanned beam display 1300 employing a photoluminescent light source 1306 according to an embodiment. The scanned beam display 1302 receives a source of an image(s), such as an image signal 1304a, which in one embodiment, will be scanned onto the retina of a viewer's eye 1314. While the system as presented in FIG. 13, scans light containing image data onto the viewer's eye 1314, the structures and concepts presented herein may be applied to other types of displays, such as projection displays that include viewing screens, etc.

Control electronics 1320 provide electrical signals that control operation of the display 1302 in response to the signal 1304a. Signal 1304a may originate from a source such as a computer, a television receiver, videocassette player, DVD player, remote sensor, or a similar device. In one or more embodiments, a similar device is an imaging sensor in a digital camera or a digital video camera, etc.

The photoluminescent light source(s) 1306 outputs a modulated light beam(s) 1308. The light beam 1308 has a modulation which corresponds to information in the image signal. The aforementioned photoluminescent light source embodiments may be used for the photoluminescent light source 1306. A scanner 1310 reflects the modulated light beam 1308 to produce scanned beam 1312 which is scanned onto a viewing screen or the retina of the viewer's eye 1314. The scanner 1310 may be a bidirectional scanner that is configured to scan the scanned beam 1312 in both the horizontal and vertical directions to produce the image. One suitable device for the scanner 1310 is a micro-electromechanical scanner (MEMS) device. Such a scanner 1310 typically includes one or more actuators configured to move a mirror (e.g., a curved mirror), diffractive element, and/or refractive element in a manner to scan a beam to form the image.

Some embodiments use a MEMS scanner for the scanner 1310. A MEMS scanner may be of a type described in, for example; U.S. Pat. No. 6,140,979, entitled SCANNED DISPLAY WITH PINCH, TIMING, AND DISTORTION CORRECTION and commonly assigned herewith; U.S. Pat. No. 6,245,590, entitled FREQUENCY TUNABLE RESONANT SCANNER AND METHOD OF MAKING and commonly assigned herewith; U.S. Pat. No. 6,285,489, entitled FREQUENCY TUNABLE RESONANT SCANNER WITH AUXILIARY ARMS and commonly assigned herewith; U.S. Pat. No. 6,331,909, entitled FREQUENCY TUNABLE RESONANT SCANNER and commonly assigned herewith; U.S. Pat. No. 6,362,912, entitled SCANNED IMAGING APPARATUS WITH SWITCHED FEEDS and commonly assigned herewith; U.S. Pat. No. 6,384,406, entitled ACTIVE TUNING OF A TORSIONAL RESONANT STRUCTURE and commonly assigned herewith; U.S. Pat. No. 6,433,907, entitled SCANNED DISPLAY WITH PLURALITY OF SCANNING ASSEMBLIES and commonly assigned herewith; U.S. Pat. No. 6,512,622, entitled ACTIVE TUNING OF A TORSIONAL RESONANT STRUCTURE and commonly assigned herewith; U.S. Pat. No. 6,515,278, entitled FREQUENCY TUNABLE RESONANT SCANNER AND METHOD OF MAKING and commonly assigned herewith; U.S. Pat. No. 6,515,781, entitled SCANNED IMAGING APPARATUS WITH SWITCHED FEEDS and commonly assigned herewith; and/or U.S. Pat. No. 6,525,310, entitled FREQUENCY TUNABLE RESONANT SCANNER and commonly assigned herewith; all hereby incorporated by reference.

In an alternative embodiment, an optional mirror 1324 is provided. The mirror 1324 shapes, focuses, and directs the scanned beam 1312 for viewing by the viewer's eye 1326, and may be a curved partially transmissive mirror. If the mirror 1324 is partially transmissive, the mirror 1324 combines the light from the scanner 1310 with the light received from the background 1328 to produce a combined input to the viewer's eye 1326. Although the background 1328 presented here is a “real-world” background (tree), the background light may be occluded as it is when the display is viewed by the viewer 1314. One skilled in the art will recognize that a variety of other structures may replace or supplement the lenses and structures shown in FIG. 13. For example, a diffractive element such as a Fresnel lens may replace the mirror 1324. Alternatively, a beam splitter and lens may replace the partially transmissive mirror structure of the mirror 1324. Other optical elements, such as polarizing filters, color filters, exit pupil expanders, chromatic correction elements, eye tracking elements, and background masks may also be incorporated for certain applications.

In various embodiments, the scanned beam display 1302 may be distributed by locating one or more components of the display 1302 in separate locations. For example, a division of a scanned beam display, as indicated by 1330, separates the control electronics 1320 and the photoluminescent light source(s) 1306 from the rest of the display system (scanner, etc.). In one embodiment, an example of this separation may occur with the illustration presented in FIG. 7. In this example, the components of 1330 (FIG. 13) are moved to the location of light source 702 in FIG. 7. Separation of the components of a scanned beam display and in particular the light source from the scanner permits the design of smaller scanners that are more convenient for mounting on a user's head gear, etc.

FIG. 14 shows a block diagram of a scanned beam imager 1400 according to an embodiment. A photoluminescent light source 1402, according to any of the aforementioned embodiments, emits a first beam of light 1408 having at least one secondary wavelength. A scanner 1410 deflects the first beam of light 1408 across a field-of-view (FOV) 1416 to produce a second scanned beam of light 1412, shown in two positions 1412a and 1412b. The scanned beam of light 1412 sequentially illuminates spots 1418 in the FOV 1416, shown as positions 1418a and 1418b, corresponding to beam positions 1412a and 1412b, respectively. While the beam 1412 illuminates the spots 1418, the illuminating light beam 1412 is reflected, absorbed, scattered, refracted, or otherwise affected by the properties of the object or material to produced scattered light energy. A portion of the scattered light energy 1420, shown emanating from spot positions 1418a and 1418b as scattered energy rays 1420a and 1420b, respectively, travels to one or more detectors 1414 that receive the light and produce electrical signals corresponding to the amount of light energy received. The electrical signals drive a controller 1406 that builds up a digital image and transmits it for further processing, decoding, archiving, printing, display, or other treatment or use via interface 1422.

Some embodiments use any of the aforementioned MEMS scanners for the scanner 1410. A 2D MEMS scanner 1410 scans one or more light beams at high speed in a pattern that covers an entire 2D FOV or a selected region of a 2D FOV within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern so as to create a progressive scan pattern. A progressively scanned bi-directional approach with a single beam scanning horizontally at scan frequency of approximately 19 KHz and scanning vertically in sawtooth pattern at 60 Hz can approximate an SVGA resolution. In one such system, the horizontal scan motion is driven electrostatically and the vertical scan motion is driven magnetically. Alternatively, both the horizontal and vertical scan may be driven magnetically or capacitively. Electrostatic driving may include electrostatic plates, comb drives or similar approaches. In various embodiments, both axes may be driven sinusoidally or resonantly.

Several types of detectors may be appropriate, depending upon the application or configuration. For example, in one embodiment, the detector 1414 may include a simple PIN photodiode connected to an amplifier and digitizer. In this configuration, beam position information may be retrieved from the scanner or, alternatively, from optical mechanisms, and image resolution is determined by the size and shape of scanning spot 1418. In the case of multi-color imaging, the detector 1414 may comprise more sophisticated splitting and filtering to separate the scattered light into its component parts prior to detection. As alternatives to PIN photodiodes, avalanche photodiodes (APDs) or photomultiplier tubes (PMTs) may be preferred for certain applications, particularly low light applications.

In some embodiments, simple photodetectors such as PIN photodiodes, APDs, and PMTs may be arranged to stare at the entire FOV, stare at a portion of the FOV, collect light retrocollectively, or collect light confocally, depending upon the application. In some embodiments the detector 1414 collects light through filters to eliminate much of the ambient light.

In some embodiments, the light emitted from the photoluminescent light source 1406 may be polarized by passing the light 1418 through a separate polarizer (not shown). In such cases, the detector 1414 may include a polarizer cross-polarized to the scanning beam 1412. Such an arrangement may help to improve image quality by reducing the impact of specular reflections on the image.

In additional embodiments, instead of using the scanner 1310 or 1410 to reflect and scan the light across a FOV, an actuator may support any of the aforementioned photoluminescent light sources. The actuator may be operable to move the photoluminescent light source in a manner so that the light emitted therefrom may be scanned across the FOV. In one suitable embodiment the actuator is a galvanometer that is operable to rotate the photoluminescent light source about one or more axes.

Although many of the embodiments have been described as using a collection lens to focus the light emitted from the photoluminescent material at the secondary wavelength to form a beam of substantially collimated light, according to alternative embodiments, a mirror (e.g., a curved spherical mirror), a diffractive optical element, or a refractive optical element may be substituted for a collection lens described herein. Accordingly, focusing devices used to form a beam from the light at the secondary wavelength may include any of such optical devices.

Although the invention has been described with reference to the disclosed embodiments, persons skilled in the art will recognize that changes may be made in form and detail without departing from the spirit and scope of the invention. In addition, many modifications may be made to adapt to a particular situation and the teaching of the invention without departing from the central scope. Therefore, it is intended that the invention not be limited to the particular embodiment disclosed as the best mode contemplated for carrying out the invention, but that the invention include all embodiments falling within the scope of the appended claims.

We claim:

1. A scanned photoluminescent light source, comprising:
an excitation light source operable to emit light at a primary wavelength;
a target optically coupled to the excitation light source, the target including a photoluminescent material having a characteristic to emit light at a secondary wavelength in response to absorbing the light at the primary wavelength;
a focusing device positioned to receive the light at the secondary wavelength and configured to reduce the divergence of the light at the secondary wavelength; and
an actuator operable to scan the light at the secondary wavelength having the reduced divergence across a field-of-view.

2. The scanned photoluminescent light source of claim 1 wherein the focusing device is configured to substantially collimate the light at the secondary wavelength.

3. The scanned photoluminescent light source of claim 1 wherein the focusing device is configured to focus the light at the secondary wavelength.

4. The scanned photoluminescent light source of claim 1, further comprising:
a first reflecting layer disposed between the excitation light source and an input portion of the target, the first reflecting layer being operative to transmit the light at the primary wavelength therethrough.

5. The scanned photoluminescent light source of claim 4 wherein the first reflecting layer comprises a distributed Bragg reflector.

6. The scanned photoluminescent light source of claim 4 wherein the first reflecting layer is reflective to at least one of red, green, and blue light.

7. The scanned photoluminescent light source of claim 4 wherein the first reflecting layer includes an aperture aligned to receive and pass the light at the primary wavelength emitted from the excitation light source to the input portion of the target.

8. The scanned photoluminescent light source of claim 7 wherein the first reflecting layer is operative to reflect light at a plurality of wavelengths including at least the primary wavelength and the secondary wavelength.

9. The scanned photoluminescent light source of claim 4, further comprising:
a second reflecting layer disposed to receive the light at the secondary wavelength, the second reflecting layer being operative to reflect at least a portion of the light at the primary wavelength.

10. The scanned photoluminescent light source of claim 9 wherein the second reflecting layer is further operative to transmit the light at the secondary wavelength.

11. The scanned photoluminescent light source of claim 9 wherein the second reflecting layer comprises a distributed Bragg reflector.

12. The scanned photoluminescent light source of claim 9 wherein the second reflecting layer is further operative to transmit at least one of red, green, and blue light.

13. The scanned photoluminescent light source of claim 9 wherein the second reflecting layer is aligned to receive the light at the primary wavelength that passes through the target without being absorbed and operative to reflect the light at the primary wavelength back into the target.

14. The scanned photoluminescent light source of claim 13 wherein the second reflecting layer is dimensioned to be substantially less than an entire output surface of the target.

15. The scanned photoluminescent light source of claim 13 wherein the second reflecting layer is operative to reflect light at a plurality of wavelengths including at least the primary wavelength and the secondary wavelength.

16. The scanned photoluminescent light source of claim 1 wherein the photoluminescent material is configured as an elongate structure.

17. The scanned photoluminescent light source of claim 16 wherein the elongate structure has a cylindrical shape.

18. The scanned photoluminescent light source of claim 1 wherein the target comprises:
an input portion optically coupled to the excitation light source;
an output portion for emitting light at the secondary wavelength; and
a reflecting structure partially surrounding the target, the reflecting structure being operative to reflect light at least at the secondary wavelength and further operative to guide the light at the secondary wavelength out of the output portion.

19. The scanned photoluminescent light source of claim 18 wherein the reflecting structure comprises at least one aperture aligned to receive and pass the light at the primary wavelength emitted from the excitation light source to the input portion of the target.

20. The scanned photoluminescent light source of claim 19 wherein the reflecting structure is operative to reflect light at a plurality of wavelengths including at least the primary wavelength and the secondary wavelength.

21. The scanned photoluminescent light source of claim 18, further comprising:
a second reflecting layer disposed adjacent to the output portion to receive the light at the secondary wavelength emitted from the output portion, the second reflecting layer being operative to reflect at least a portion of the light at the primary wavelength.

22. The scanned photoluminescent light source of claim 21 wherein the second reflecting layer is operative to reflect light at a plurality of wavelengths including at least the primary wavelength and the secondary wavelength and wherein the second reflecting layer is configured to pass a portion of the light at the secondary wavelength.

23. The scanned photoluminescent light source of claim 18 wherein the excitation light source comprises a plurality of excitation light sources, each of the plurality of excitation light sources operable to emit light at one or more primary wavelengths.

24. The scanned photoluminescent light source of claim 1 wherein the photoluminescent material comprises a fluorescent material.

25. The scanned photoluminescent light source of claim 1 wherein the photoluminescent material comprises a phosphorescent material.

26. The scanned photoluminescent light source of claim 1 wherein the photoluminescent material comprises at least one of coumarin, fluorescein, rhodamine, neodimium doped yttrium aluminum Garnet (Nd:YAG) (Y₃Al₅O₁₂:Nd), zinc sulfide doped with copper and aluminum (ZnS:Cu,Al), (SrCaBa)₅Cl(PO₄)₃:Eu, yttrium oxysulfide doped with europium (Y₂O₂S:Eu), and Mg₄FlGeO₆:Mn.

27. The scanned photoluminescent light source of claim 1 wherein the target comprises a plurality of nanoparticles, the plurality of nanoparticles having a range of different photoluminescent characteristics.

28. The scanned photoluminescent light source of claim 1 wherein the photoluminescent material is configured as a film.

29. The scanned photoluminescent light source of claim 28 wherein the film comprises epitaxially grown semiconductor material.

30. The scanned photoluminescent light source of claim 1 wherein the photoluminescent material comprises a solvated fluorescent material, photoluminescent particles dispersed in a polymer matrix, a fluorescing ion in a glass medium, a short chain organic dye in a polymer medium, or a long chain organic dye.

31. The scanned photoluminescent light source of claim 1 wherein the photoluminescent material comprises an up-converting photoluminescent material.

32. The scanned photoluminescent light source of claim 1, wherein the photoluminescent material comprises a down-converting photoluminescent material.

33. The scanned photoluminescent light source of claim 1, further comprising:
a lens structure positioned to receive the light at the primary wavelength emitted from the excitation source.

34. The scanned photoluminescent light source of claim 33 wherein the lens structure comprises a collection lens spaced apart from a focus lens, the focus lens configured to focus the light at the primary wavelength received from the collection lens onto the target.

35. The scanned photoluminescent light source of claim 33, further comprising:
a first lens element disposed adjacent a first side of the target, the first lens element configured to focus light at the primary wavelength onto the photoluminescent material; and
a second lens element disposed adjacent a generally opposing second side of the target, the second lens element configured to focus light at the secondary wavelength emitted from the photoluminescent material.

36. The scanned photoluminescent light source of claim 1 wherein the excitation light source comprises a plurality of excitation light sources; and
wherein the target comprises a plurality of discrete photoluminescent materials, each of the plurality of discrete photoluminescent materials optically coupled to one of the plurality of excitation light sources.

37. The scanned photoluminescent light source of claim 36 wherein each of the plurality of discrete photoluminescent materials has different photoluminescent characteristics.

38. The scanned photoluminescent light source of claim 1 wherein target comprises a plurality of discrete photoluminescent materials arranged in an array, each of the plurality of discrete photoluminescent materials; and
wherein the excitation light source comprises a plurality of excitation light sources, each of the plurality of excitation light sources optically coupled to one of the plurality of discrete photoluminescent materials of the array.

39. The scanned photoluminescent light source of claim 1, further comprising:
collection optics positioned to receive the light at the primary wavelength;
a beam splitter positioned to receive the light at the primary wavelength from the collection optics, the beam splitter operative to transmit the light at the primary wavelength and reflect the light at the secondary wavelength; and
wherein the focusing device is configured to focus the light at the secondary wavelength transmitted through the beam splitter onto the photoluminescent material.

40. The scanned photoluminescent light source of claim 1 wherein the secondary wavelength is within the visible spectrum.

41. The scanned photoluminescent light source of claim 1 wherein the secondary wavelength is within the non-visible spectrum.

42. The scanned photoluminescent light source of claim 1 wherein a color associated with the primary wavelength is approximately violet or ultraviolet.

43. The scanned photoluminescent light source of claim 1 wherein the primary wavelength is not within the visible spectrum.

44. The scanned photoluminescent light source of claim 1 wherein the focusing device comprises at least one of a lens, a mirror, a refractive optical element, and a diffractive optical element.

45. The scanned photoluminescent light source of claim 1 wherein the actuator further comprises a support carrying the excitation light source, target, and focusing device; and further wherein the actuator is operative to rotate the support to scan the light at the secondary wavelength having the reduced divergence.

46. The scanned photoluminescent light source of claim 1, further comprising an optical element coupled to the actuator and positioned to receive the light at the secondary wavelength having the reduced divergence, the actuator being operable to scan the light at the secondary wavelength having the reduced divergence received by the optical element.

47. The scanned photoluminescent light source of claim 46 wherein the optical element comprises at least one of a mirror, diffractive element, and refractive element.

48. A photoluminescent light source, comprising:
an excitation light source operable to emit light at a primary wavelength;
one or more optical waveguides optically coupled to the excitation light source, each of the one or more optical waveguides comprising a photoluminescent material having a characteristic to emit light at a secondary wavelength in response to absorbing the light at the primary wavelength; and
gathering optics oriented to receive the emitted light at the secondary wavelength and configured to produce a desired optical output at the secondary wavelength.

49. The photoluminescent light source of claim 48 wherein each of the one or more optical waveguides comprises:
a core comprising the photoluminescent material;
a first cladding surrounding the core, the first cladding having an index of refraction less than an index of refraction of the core; and
a second cladding surrounding the first cladding, the second cladding having an index of refraction less than an index of refraction of the first cladding.

50. The photoluminescent light source of claim 48 wherein each of the one or more optical waveguides comprises:
a core;
a first cladding comprising the photoluminescent material, the first cladding surrounding the core and having an index of refraction less than an index of refraction of the core; and
a second cladding surrounding the first cladding, the second cladding having an index of refraction less than an index of refraction of the first cladding.

51. The photoluminescent light source of claim 48 wherein each of the one or more optical waveguides have different photoluminescent characteristics.

52. The photoluminescent light source of claim 48, further comprising:
coupling optics configured to couple the light at the primary wavelength into each of the one or more optical waveguides.

53. The photoluminescent light source of claim 48 wherein the photoluminescent material comprises a fluorescent material.

54. The photoluminescent light source of claim 48 wherein the photoluminescent material comprises a phosphorescent material.

55. The photoluminescent light source of claim 48 wherein the photoluminescent material comprises at least one of coumarin, fluorescein, rhodamine, neodimium doped yttrium aluminum Garnet (Nd:YAG), Y₃Al₅O₁₂:Nd, zinc sulfide doped with copper and aluminum (ZnS:Cu,Al), zinc cadmium sulfide doped with copper and aluminum (ZnCdS:Cu,Al), strontium thiogallate doped with europium (SrGa₂S₄:Eu), and yttrium oxysulfide doped with europium (Y₂O₂S:Eu).

56. The photoluminescent light source of claim 48 wherein the photoluminescent material comprises an up-converting photoluminescent material.

57. The photoluminescent light source of claim 48 wherein the photoluminescent material comprises a down-converting photoluminescent material.

58. The photoluminescent light source of claim 48 wherein the excitation light source is optically coupled to an end of each of the one or more optical waveguides.

59. A method of providing light to form an image, comprising:
directing light at a primary wavelength onto a target comprising a photoluminescent material;
absorbing at least a portion of the light at the primary wavelength with the target;
emitting light at a secondary wavelength from the target;
reducing the divergence of the light at the secondary wavelength; and
forming the image with the light at the secondary wavelength having the reduced divergence.

60. The method of claim 59 wherein the act of directing light at a primary wavelength onto a target comprising a photoluminescent material comprises transmitting the light at the primary wavelength through a first reflecting surface.

61. The method of claim 59 wherein the act of transmitting the light at the primary wavelength through a first reflecting surface comprises transmitting the light at the primary wavelength through an aperture in the first reflecting surface.

62. The method of claim 61 wherein the first reflecting surface is operative to reflect the light at a plurality of wavelengths including at least the primary wavelength and the secondary wavelength.

63. The method of claim 59, further comprising:
transmitting at least a portion of the light at the secondary wavelength past a second reflecting surface.

64. The method of claim 63 wherein the second reflecting surface is operative to reflect the light at a plurality of wavelengths including at least the primary wavelength and the secondary wavelength.

65. The method of claim 63, further comprising selectively reflecting light at the primary wavelength that is not absorbed by the target from the second reflecting surface.

66. The method of claim 59, further comprising:
guiding the light at the secondary wavelength out of an output portion of the photoluminescent material.

67. The method of claim 59 wherein the act of directing light at a primary wavelength onto the target comprises focusing the light at the primary wavelength onto the target.

68. The method of claim 59, further comprising:
altering a direction of the light at the secondary wavelength emitted from the target.

69. The method of claim 68 wherein the act of altering a direction of the light at the secondary wavelength emitted from the target includes using a beam splitter.

70. The method of claim 59 wherein the target comprises an optical waveguide comprising the photoluminescent material.

71. The method of claim 59 wherein the act of reducing the divergence of the light at the secondary wavelength comprises substantially collimating the light at the secondary wavelength.

72. The method of claim 71 wherein the act of forming the image with the light at the secondary wavelength having the reduced divergence comprises scanning the substantially collimated light in at least one dimension.

73. The method of claim 59 wherein the act of forming the image with the light at the secondary wavelength having the reduced divergence comprises scanning the light at the secondary wavelength having the reduced divergence in at least one dimension.

74. A method of providing light to form an image, comprising:
generating light from a plurality of light sources, each of the plurality of light sources emitting light at a selected primary wavelength;
absorbing at least a portion of the light at the selected primary wavelength emitted from each of the plurality of light sources with a corresponding target comprising a photoluminescent material;
emitting light at a selected secondary wavelength from each of the targets;
reducing the divergence of the light at the selected secondary wavelength emitted from each of the targets; and
forming the image with the light at the selected secondary wavelength having the reduced divergence.

75. The method of claim 74 wherein the selected primary wavelength of each of the plurality of light sources is less than the selected secondary wavelength of the corresponding photoluminescent materials.

76. The method of claim 74 wherein the selected primary wavelength of each of the plurality of light sources is greater than the selected secondary wavelength of the corresponding photoluminescent materials.

77. The method of claim 74 wherein the act of forming the image with the light at the selected secondary wavelength having the reduced divergence comprises scanning the beam in at least one direction.

78. The method of claim 74 wherein the act of reducing the divergence of the light at the secondary wavelength comprises substantially collimating the light at the selected secondary wavelength.

79. The method of claim 78 wherein the act of forming the image with the light at the selected secondary wavelength having the reduced divergence comprises scanning the substantially the substantially collimated light in at least one dimension.

80. The method of claim 74 wherein the light at the selected secondary wavelength emitted from each of the targets have different respective wavelengths.

81. A scanned beam imager, comprising:
(a) a photoluminescent light source comprising:
(i) an excitation light source operable to emit light at a primary wavelength; and
(ii) a target optically coupled to the excitation light source, the target including a photoluminescent material having a characteristic to emit light at a secondary wavelength in response to absorbing the light at the primary wavelength;
(b) a scanner operable to direct the light at the secondary wavelength emitted from the target across a field-of-view; and
(c) at least one light detector positioned to receive at least a portion of the directed light scattered from the field-of-view.

82. A scanned beam display, comprising:
(a) a photoluminescent light source comprising:
(i) an excitation light source operable to emit modulated light at a primary wavelength; and
(ii) a target optically coupled to the excitation light source, the target including a photoluminescent material having a characteristic to emit light at a secondary wavelength in response to absorbing the light at the primary wavelength;
(b) a scanner operable to direct the light at the secondary wavelength emitted from the target onto an image surface; and
(c) at least one controller coupled to and operable to modulate the photoluminescent light source.
